(19) United States
(12) Patent Application Publication
(10) Pub. No.: US 2014/0263471 A1
(43) Pub. Date: Sep. 18, 2014

(54) ROTARY MEASURING DISPENSER

(71) Applicant: GenEon Technologies LLC, San Antonio, TX (US)

(72) Inventors: Remigio Benavides Gonzalez, San Antonio, TX (US); Dario Eduardo Rodriguez Quintanilla, Monterrey (MX)

(73) Assignee: GenEon Technologies LLC, San Antonio, TX (US)

(21) Appl. No.: 14/206,687

(22) Filed: Mar. 12, 2014

Related U.S. Application Data
(60) Provisional application No. 61/784,028, filed on Mar. 14, 2013.

(51) Int. Cl. G01F 11/46

(52) U.S. Cl. CPC G01F 11/46
USPC 222/438

(57) ABSTRACT

A measuring dispenser is described that employs a dispensing head that connects to a container with particulate solids that are intended to be measured and dispensed. The dispensing head employs a rotor with an adjustable sized measuring receptacle. As the rotor is turned, the particulate solids are accurately measured and dispensed out of a discharge port. The measuring receptacle is designed to receive a structure that reduces the size of the measuring receptacle to a predetermined volume. In an embodiment, the measuring receptacle is cylindrical and threaded. A plug is screwed into the measuring receptacle to adjust the measuring receptacle to a predetermined volume. In an alternative embodiment, an insert cup is snapped into the measuring receptacle to provide a desired measuring volume. This insert cup may be changed to adjust the volume being measured.

### CROSS-REFERENCE TO RELATED APPLICATIONS

This application claims the benefit of the following provisional applications, each of which is hereby incorporated by reference in its entirety:

U.S. Provisional Application No. 61/784,028, filed Mar. 14, 2013.

### BACKGROUND OF THE INVENTION

1. Field

The novel device described herein generally relates to a device for measuring and dispensing particulate solids and more specifically to a device for measuring and dispensing particulate solids using an adjustable rotary valve.

2. Discussion of Related Art

There have been various devices for measuring out a predetermined amount of material, such as a powder, then dispensing the powder. The prior art has gone one step further by also providing rotary measuring dispensers that have adjustable measuring receptacles. One such prior art device, U.S. Pat. No. 4,162,751, issued Jul. 31, 1979 entitled “Rotary Measuring Chamber With Size Adjustment” describes a system using a mechanical gear system to alter the size of the measuring chamber. However, this device tends to be larger, more complicated and due to the gears, more apt to jam when used.

Currently, there is a need for a simple and effective measuring dispenser.

### SUMMARY OF THE INVENTION

The present invention may be embodied as a dispensing head for measuring and dispensing a volume of particulate solids from a source of particulate solids having a discharge port for dispensing the particulate solids, a rotary valve coupled to the source of particulate solids and the discharge port. The rotary valve includes a measuring receptacle adapted to receive said particulate solids from said source of particulate solids and measure a predetermined volume of said particulate solids.

The measuring receptacle is adapted to removeably receive a structure that fits in the measuring receptacle and reduces a volume of the measuring receptacle to the predetermined volume.

The present invention may also be embodied as a measuring dispenser designed to measure an adjustable volume of particulate solids contents. The measuring dispenser has a container for holding and storing said particulate solids and a dispensing head for measuring and dispensing a volume of particulate solids from a source of particulate solids. The dispensing head has a discharge port for dispensing the particulate solids, a rotary valve coupled to the source of particulate solids and the discharge port. The rotary valve includes a measuring receptacle adapted to receive said particulate solids from said source of particulate solids and measure a predetermined amount of said particulate solids. A structure is sized and designed to fit into the measuring receptacle and reduces a volume of the measuring receptacle to a predetermined volume.

### BRIEF DESCRIPTION OF THE FIGURES

The invention and the following detailed description of certain embodiments thereof may be understood by reference to the following figures:

FIG. 1 shows an assembled perspective view of the measuring dispenser according to one embodiment of the present invention in an upright position.

FIG. 2 shows an assembled perspective view of the measuring dispenser of FIG. 1 in a dispensing position.

FIG. 3 is an exploded perspective view of a measuring dispenser according to FIGS. 1 and 2 in an upright position.

FIG. 4 is a perspective view of the measuring dispenser of FIGS. 1-3 from below, with the container removed for clarity.

FIG. 5 is a perspective view of one embodiment of the rotor showing the adjustable measuring receptacle.

FIG. 6 is a side sectional, elevational view of one embodiment of the rotor of FIG. 5.

### DETAILED DESCRIPTION OF THE PREFERRED EMBODIMENT(S)

FIG. 1 shows an assembled perspective view of the measuring dispenser 100 according to one embodiment of the present invention in an upright position.

The measuring dispenser has a container 220 containing powdered or granular particulate solids that are to be measured and dispensed.

A dispensing section 103 is connected to the container 220 such that the contents will pass from the container 220 to the dispensing portion without leaking A cover 190 covers an internal rotary valve that is operated by a rotor handle 141.

A cap 210 plugs a discharge port 183 so that the material will not accidently be released.

FIG. 2 shows an assembled perspective view of the measuring dispenser 100 of FIG. 1 in a dispensing position. In this position, the contents of container 220 falls downward to the dispensing head 103. As rotor handle 141 is turned as shown by the arrow, the internal measuring receptacle is filled with contents, and then released out of discharge port 183.

FIG. 3 is an exploded perspective view of a measuring dispenser 100 according to FIGS. 1 and 2 in an upright position.

Here it can more clearly be seen that container 220 has a threaded container connection 221 that is received by a dispenser head connection 105 to secure the two together.

The cover 190 and cap 220 can be seen here. The dispenser head section 103 further includes a valve housing, shown here as two valve half housings 123, 125. The valve housings 123, 125 fit together to create a rotor recess 129. It should be noted that valve housing can be made from multiple parts or from a single formed part. Rotor 140 fits within rotor recess 129. An ‘O’-ring 149 fits around the rotor to seal it. The rotor has a measuring receptacle 151 that is designed to receive various sized inserts to reduce the size of the measuring receptacle 151 to a predetermined volume. This is volume is the measured amount that is dispensed.

FIG. 4 is a perspective view of the measuring dispenser 100 of FIGS. 1-3 from below, with the container 220 in phantom for clarity.

In this view, the sloping surface 125 can be seen. The particulate solids of container 220 slide down this sloping surface 125 to a central opening 127. The contents then fall into the measuring receptacle 151 of rotor 140. As the rotor is turned, this volume of the contents is dispensed out of discharge port 183.

Since the amount dispensed may need to be changed, there are different ways to change the volume of measuring receptacle 151. These are further described below in connection with FIGS. 5 and 6.

FIG. 5 is a perspective view of one embodiment of the rotor 140 showing the adjustable measuring receptacle 151.

FIG. 6 is a side sectional, elevational view of one embodiment of the rotor 140 of FIG. 5.

The rotor 140 will now be described with reference to both FIGS. 5 and 6. The rotor 140 having the parts as described up until this point, with the addition of the adjustable measuring receptacle 151. In the embodiment shown, measuring receptacle 151 has a circular cross-section and is threaded. A plug 153 is screwed into the recess to a point where the volume of the measuring receptacle 151 is set to a predetermined volume. The plug 153 has an inset 155. The inset 155 shown here is a hexagonal depression that is sized to be driven by a tool, such as an Allen Wrench. Therefore, the tool may be inserted into the inset 155 (as indicated by arrow “A” of FIG. 6). The tool is used to screw in the plug 153 inward or outward as necessary to crate the proper volume.

The inset 155 could be star shaped, square or any regular or irregular shape, as long as the tool has a complementary shape. If a unique shape is used, it would insure that only those with the tool for this shape would be able to adjust the plug. Use of a unique shape for the inset and tool would be desirable in cases where the volume of the measuring receptacle 151 is set and the user is intended to be precluded from making further adjustments to the volume of the measuring receptacle 151.

In still another embodiment, there may be a small opening along the arrow “B” in FIG. 6 that is plugged when not in use. This would provide access to the opposite side of plug 153. If there were an inset on this side, then a tool with a complementary shape may be used to adjust the plug 153 inward or outward. This is an advantage since this side will not have any of the contents of the container 220 that the measuring recess 151 receives. Therefore there would be less chance of having caking and otherwise obstructing a tool from adjusting the plug 153. In an embodiment, the opening may have a cap that can be locked, as indicated above. These may require a key or special tool to unlock the cap to allow access through the opening. Only then would there be access to adjust the volume of the measuring receptacle 151.

In still another embodiment, the plug 153 can be replaced with preformed insert cup having a predetermined volume. There may be several different insert cups of varying volumes. These may have clips or teeth that interact with structures within the measuring receptacle to removeably hold the insert cup in place. These may snap in and out. As indicated above, an opening may be made in the rotor where arrow “B” of FIG. 6 intersects the rotor 140. A tool may be inserted under the insert cup to pop it out of measuring receptacle 151 to remove or replace the insert cup. In an embodiment, the opening may be fitted with a cap that can be locked preventing users form adjusting the measuring receptacle volume. This cap may require a special key or tool that would allow the cap to be removed and allow access to the measuring receptacle 151 and insert cup 159. This would prevent those without the key or special tool from tampering with or replacing the insert cups.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A dispensing head for measuring and dispensing a volume of particulate solids from a source of particulate solids comprising:
a discharge port for dispensing the particulate solids; and
a rotary valve coupled to said source of particulate solids and the discharge port, the rotary valve including a measuring receptacle adapted to receive said particulate solids from said source of particulate solids and measure a predetermined amount of said particulate solids;
wherein the measuring receptacle is adapted to removeably receive a structure that fits in the measuring receptacle and reduces a volume of the measuring receptacle to a predetermined volume.

2. The dispensing head of claim 1 wherein the rotary valve comprises:
a valve housing having a rotor recess; and
a rotor fitting within the rotor recess for carrying the measuring receptacle.

3. The dispensing head of claim 1 wherein the measuring receptacle is threaded and the structure is a threaded plug that screws into the measuring receptacle to adjust its volume.

4. The dispensing head of claim 1 wherein the structure is an insert cup that fits into the measuring receptacle to adjust its volume.

5. The dispensing head of claim 1 wherein the source of said particulate solids is a container.

6. The dispensing head of claim 5 wherein the container is adapted to connect with the dispensing head to create a conduit between the container and the dispensing head.

7. The dispensing head of claim 2 wherein the particulate solids are powdered solids.

8. The dispensing head of claim 2 wherein the particulate solids are granular solids.

9. The dispensing head of claim 2 further comprising:
a rotor handle attached to the rotor allowing it to be rotated.

10. A measuring dispenser adapted to measure an adjustable volume of particulate solids contents, comprising:
a container for holding and storing said particulate solids,
a dispensing head for measuring and dispensing a volume of particulate solids from a source of particulate solids comprising:
a discharge port for dispensing the particulate solids; and
a rotary valve coupled to said source of particulate solids and the discharge port the rotary valve including a measuring receptacle adapted to receive said particulate solids from said source of particulate solids and measure a predetermined amount of said particulate solids;
wherein the measuring receptacle is adapted to removeably receive a structure that fits in the measuring receptacle and reduces a volume of the measuring receptacle to a predetermined volume.

11. The dispensing head of claim 10 wherein the rotary valve comprises:
a valve housing having a rotor recess; and
a rotor fitting within the rotor recess for carrying the measuring receptacle.

12. The dispensing head of claim 10 wherein the measuring receptacle is threaded and the structure is a threaded plug that screws into the measuring receptacle to adjust its volume.

13. The dispensing head of claim 10 wherein the structure is an insert cup that fits into the measuring receptacle to adjust its volume.

14. The dispensing head of claim 10 wherein the source of said particulate solids is a container.

15. The dispensing head of claim 14 wherein the container is adapted to connect with the dispensing head to create a conduit between the container and the dispensing head.

16. The dispensing head of claim 11 further comprising:
a rotor handle attached to the rotor allowing it to be rotated.
